(19) United States
(12) Patent Application Publication
(10) Pub. No.: US 2010/0017829 A1
(43) Pub. Date: Jan. 21, 2010

(54) REAL TIME RADIO-BASED TELEVISION PROGRAMMING APPARATUS AND METHOD

(75) Inventor: Leland William Spieckerman, Fort Worth, TX (US)

Correspondence Address: Mr. Christopher John Rourk;Jackson Walker LLP, 901 Main Street, Suite 6000, DALLAS, TX, 75202, US

(73) Assignee: SPIECKERMANMEDIA LLC, Fort Worth, TX (US)

(21) Appl. No.: 12/505,267

(22) Filed: Jul. 17, 2009

Related U.S. Application Data
(60) Provisional application No. 61/135,123, filed on Jul. 17, 2008.

(51) Int. Cl. H04N 7/173

(52) U.S. Cl. 725/93

(57) ABSTRACT

An apparatus for providing real time radio-based audiovisual content that includes a radio station audio and video data system providing at least one audio channel and at least one video channel associated with a radio station program.

### RELATED APPLICATIONS

This application claims priority to U.S. Provisional application Ser. No. 61/135,123, filed Jul. 17, 2008, which is hereby incorporated by reference for all purposes.

### FIELD OF THE INVENTION

The invention relates to television programming in general, and more particularly to a television programming apparatus and method that receives audio and data streams from local radio stations and integrates it with video from cameras placed at the radio station, other audiovisual content, news “tickers” and graphics to generate television programming on cable, satellite and/or IPTV television channels (or television content streams) which are co-branded with the associated local radio stations.

### BACKGROUND OF THE INVENTION

It is known to broadcast radio station audio feeds in real time over a television channel, or to place video cameras in a radio station studio for a relatively small amount of the television programming schedule on a cable, broadcast or satellite television channel which is not otherwise branded or associated with the radio station. These two scenarios represent polar extremes, with the first including no video emanating from the radio station whatsoever but providing a real time continuous feed, and the other simply providing camera video of those appearing in radio station programming but no associated music videos when the station airs songs from its playlist and no electronic linkage to the radio station's programming log, playout system or audio mix board to enable production of a truly parallel television offering on a dedicated and co-branded cable, satellite or IPTV television channel or television content stream. Furthermore, no offering currently exists whereby local cable, satellite and/or IPTV television channels (or television content streams) are offered in multiple markets, each connected and co-branded with one or more local radio stations in each market, with all connected to a central network operations center which monitors, can control and provides audiovisual content for each of the local television channels (or television content streams).

### SUMMARY OF THE INVENTION

In accordance with the present invention, an apparatus and method for providing real time and/or near real time local radio station-based television programming apparatus and method are provided, which allow local radio station audio, video from cameras positioned at the radio station and audiovisual content associated with that airing on the radio station to be continuously mixed, with the aid of program log data, radio station automation system data and radio station audio mix board control signals, to provide audiovisual material for a cable, satellite or IPTV television channel (or television content stream) airing in the same local market where the radio station broadcasts.

In accordance with an exemplary embodiment of the present invention, an apparatus for providing real time or near real time local radio station-based audiovisual content is provided. The apparatus includes hardware linked to a local radio station's traffic system, automation system and audio mix board and to a television network operations center that integrates audio from that local radio station, video cameras positioned at that radio station and audiovisual content associated with the local radio station's programming, a file content data system providing file content associated with the radio station program, an on demand content system providing on demand content in response to control data received from a user, a news and weather feed system providing news and weather data associated with a location, a RadioVision system compiling the local radio station audio and the audiovisual content associated with the radio station program, the file content, the local content, the on demand content and the news and weather data into a RadioVision channel of audiovisual data, RadioVision the file content, the local content, the on demand content and the news and weather data and a network operations center receiving the RadioVision channel and a plurality of other local RadioVision channels and modifying one or more of the audio streams and the video streams associated with the local radio station programs, the file content, the local content, the on demand content and the news and weather data.

Those skilled in the art will further appreciate the advantages and superior features of the invention together with other important aspects thereof on reading the detailed description that follows in conjunction with the drawings.

### BRIEF DESCRIPTION OF THE SEVERAL VIEWS OF THE DRAWINGS

FIG. 1 is a diagram of a RadioVision system in accordance with an exemplary embodiment of the present invention.

### DETAILED DESCRIPTION OF PREFERRED EMBODIMENTS

In the description that follows, like parts are marked throughout the specification and drawings with the same reference numerals, respectively. The drawing figures might not be to scale and certain components can be shown in generalized or schematic form and identified by commercial designations in the interest of clarity and conciseness.

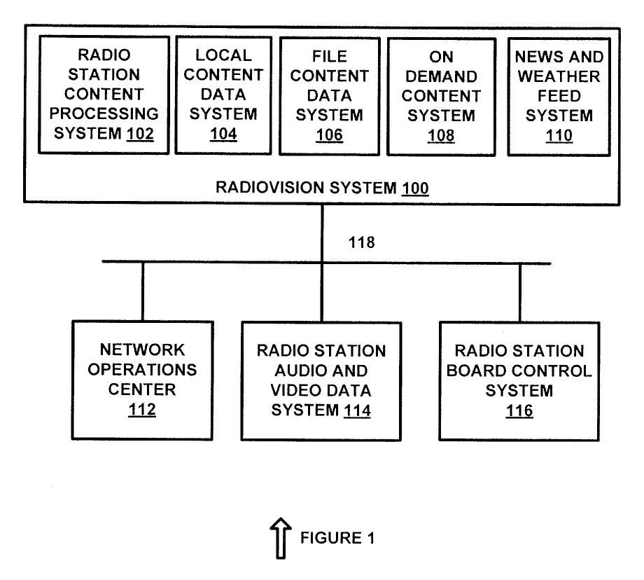

FIG. 1 is a diagram of a RadioVision system 100 in accordance with an exemplary embodiment of the present invention. RadioVision system 100 can be implemented in hardware or a suitable combination of hardware and software, and can include software systems operating on hardware platforms.

RadioVision system 100 includes radio station content processing system 102, on demand content system 108, news and weather feed system 110, network operations center 112 and Local Integration Server 114. RadioVision system 100 allows a real time radio station-based television channel (or television content stream) to be provided that includes radio station audio content, video content that can include radio on-air personalities in action, on-air guests, music videos, still images, local and national news stories, advertising, weather and other content, so as to allow a radio station's programming be the basis of a localized cable, satellite or IPTV television channel (or television content stream).

Radio station content processing system 102 receives radio station audio, signals from video cameras positioned at the local radio station and audiovisual content from any local radio station remote broadcasts. This is transmitted to the Local Integration Server 114 via communications medium 118.

Local Integration Server 114 ingests and stores audiovisual content such as advertising, music videos, local features and promotional elements related to the radio station's programming and integrates it with audiovisual content from radio station content processing system 102, graphics composed from data received from the news and weather feed system 110 and content from on demand content system 108. It then creates a program log and playlist associated with input from data streams from the local radio station's traffic system and on-air automation system, plus triggers from the radio station's audio mix board and other suitable automated processing and/or manual control. Manual control over the Local Integration Server 114 can also or alternatively be executed by network operations center 112 or other suitable systems. The Local Integration Server 114 can also delay live content, such as the radio station simulcasts, for standards purposes and/or to account for timing anomalies between the RadioVision programming and the live radio broadcasts from the associated local radio station.

On demand content system 108 stores on demand content, such as archived video content tied to the RadioVision channel, advertiser-produced or branded content and features appropriate to that particular format channel or other suitable on demand content and provides the on demand content to the Local Integration Server 114 or directly to local cable systems which can integrate the on demand content into the RadioVision channel (or television content stream), such as in response to a user request for on demand content or in other suitable manners. On demand content system can receive control data from programming keywords, network operations center 112 or other suitable sources and can generate associated user-select able controls to allow viewers to select and order on demand content. On demand content system 108 also interfaces with user accounting systems to assess charges to a user account when on demand programming with an associated charge is ordered or advertised products or services are ordered by a user. The on demand content can be used to generate the RadioVision audiovisual channel data, such as may be provided in one of a number of windows in the RadioVision audiovisual channel.

News and weather feed system 110 provides news and weather for a RadioVision audiovisual channel. In one exemplary embodiment, news and weather feed system 110 provides scrolling news feeds, local weather maps and radar, and other suitable news and weather data, such as may be provided in one of a number of windows in or superimposed over the RadioVision audiovisual channel by the Local Integration Server 114.

Network operations center 112 provides supervisory control of RadioVision audiovisual channels and continually transmits audiovisual content to the Local Integration Server 114 to be integrated with the local audiovisual content. In one exemplary embodiment, network operations center 112 can monitor content being provided on RadioVision audiovisual channels, can transmit control data to the individual Local Integration Server 114 and can perform other suitable functions to monitor and control the operation of RadioVision audiovisual channels. Network operations center 112 can be located with RadioVision system 100, in a physically separate location, and can also or alternatively monitor and control the operations of a plurality of distributed RadioVision systems 100.

RadioVision system 100 can provide a predetermined number of full-time digital cable television channels (or television programming streams) of primarily live programming. In one exemplary embodiment, each channel can be tied to a local radio station 24/7 and can consist primarily of simulcasts of the radio station's programming. The programming can he supplemented by documentary-style features and advertiser/music industry-created content, replays, “best of,” appropriately formatted music shows or other suitable content, and controls for selecting the content can be derived from the radio station programming data (such as song titles or news story titles), received from a radio station control, or can be otherwise continuously generated or provided in real time or near real-time.

RadioVision system 100 can integrate the radio station's technical infrastructure with the RadioVision plant, allowing a seamless mixing and production using local radio station traffic, automation and playout systems and control of audio and video through the radio station mixer board. This will enable RadioVision to create a parallel television event list and audiovisual television content stream for its TV channel in conjunction with each radio station's log every day (with contemporaneous updates). Video camera data and an audio mix (either with or without studio audio) from each radio station can include on-air talent, guests and callers can be events that are integrated into a decoupled TV event list, with a signal delay to accommodate timing anomalies and prevent airing of indecent content.

Based on a pre-downloaded radio station log or other suitable data, a daily log can be automatically built for use with generation of television programming, with predetermined “cover” events such as music videos, video features, full-screen traffic cam or radar, as required. Live mix board triggers can be used to trigger appropriate audio/video events on the associated RadioVision channel.

Automated or minimal human intervention switching can be performed at a national network operation center (NOC). To minimize backhaul bandwidth, no more than one broadcast quality video stream, consisting of signals from the video cameras positioned at the local radio station should emanate from each local radio station. Switching between cameras at each local radio station studio can be performed by voice-activation (video follows audio), remote IP control, locally-based personnel and/or other suitable control signals or a suitable combination of control signals. NOC personnel can have the ability to remotely control cameras at each radio station studio, which can also have control systems loaded with “shot boxes” of predetermined composition presets to capture radio station personalities, in-studio guests and other images. The voice-activated camera switching and camera robotics can be overridden by the NOC, personnel on-site at the radio station studio or other suitable personnel.

The selected camera shots and audio from each local radio station can be transmitted to the NOC and/or the Local Integration Server 114 via the least expensive path that will ensure sufficient quality of service (QOS), such as over a fiber optic media, IPTV over Internet or in other suitable manners.

The integrated program for each RadioVision channel can be transmitted to all cable headends in each local market. In this manner, minimum personnel and hardware is needed at each local radio station location across the country, although a less-centralized approach utilizing more technology at the local level can also or alternatively be utilized. Local radio station liaison personnel and two commercial/local elements shooters/editors can also be used in each market where there are a number of radio station channels being provided. In one exemplary embodiment, low cost workstations with Final Cut Pro or Avid software can be used to create local video elements, which can be file-transferred to the Local Integration Server 114 and/or NOC server for playout.

To enhance scalability and quality control, a national NOC can be used to serve all markets. Two or more alternative configurations can be used to produce the local RadioVision channels in each market, including 1) backhaul the video from the remote radio station partners to the central national NOC, then send the integrated feed back to the cable headends via C-Band . . . or another outbound distribution pipe all headends can receive, and 2) integrate live camera shots, video elements and graphics locally and automatically in each market and centrally monitor and control the channels at the national NOC using local cable/telco loops and/or microwave to distribute to the headends in each market.

In addition to a linear iteration, RadioVision can be used to provide an interactive version of the associated channels. In this exemplary embodiment, viewers can select displayed visual content elements, such as video tiles, and can drill deeper into content and advertiser messages or trigger video on demand content that is tied to the format (such as “Best Of,” local features, music videos from the Linear program playlist or other suitable material). The interactive features can be built around the same core, real-time content carried on the linear channels, such as live simulcasts of the radio station's local personalities integrated with music videos synchronized to the radio station's music playlists.

Unlike World Wide Web content provision, RadioVision is, for copyright and AFTRA purposes, a traditional television programming service that is not subject to new DMCA or AFTRA Web royalties or recordkeeping requirements, but only to existing cable programming copyright fees and rules.

While certain exemplary embodiments have been described in detail and shown in the accompanying drawings, it is to be understood that such embodiments are merely illustrative of and not restrictive on the broad invention. It will thus be recognized to those skilled in the art that various modifications may be made to the illustrated and other embodiments of the invention described above, without departing from the broad inventive scope thereof. It will be understood, therefore, that the invention is not limited to the particular embodiments or arrangements disclosed, but is rather intended to cover any changes, adaptations or modifications which are within the scope and the spirit of the invention defined by the appended claims.

What is claimed is:

1. An apparatus for providing real time ore near real time radio station-based audiovisual content, comprising:
a radio station audio and video data system providing at least one audio channel and at least one video channel associated with a radio station program;
a local content system providing local content associated with the radio station program;
a file content data system providing file content associated with the radio station program;
an on demand content system providing on demand content in response to control data received from a user;
a news and weather feed system providing news and weather data associated with a location;
a RadioVision system compiling the audio channel and the video channel associated with the radio station program, the file content, the local content, the on demand content and the news and weather data into a RadioVision television channel (or television content stream) of audiovisual data;
Local Integration Server receiving the RadioVision channel of audiovisual data and modifying one or more of the audio channel and the video channel associated with the radio station program, the file content, the local content, the on demand content and the news and weather data; and
a network operations center receiving the RadioVision channel and a plurality of other RadioVision channels and modifying one or more of the audio channel and the video channel associated with the radio station program, the file content, the local content, the on demand content and the news and weather data.
